(19) United States
(12) Patent Application Publication
(10) Pub. No.: US 2026/0189398 A1
(43) Pub. Date: Jul. 2, 2026

(54) INFORMATION PROCESSING SYSTEM GENERATOR-SIDE APPARATUS, USER-SIDE APPARATUS, MANAGEMENT METHOD, VERIFICATION METHOD, AND COMPUTER-READABLE STORAGE MEDIUM

(71) Applicants: SoftBank Corp., Tokyo (JP); AIZIP Inc., Cupertino, CA (US)

(72) Inventors: Yuko ISHIWAKA, Tokyo (JP); Shun OGAWA, Tokyo (JP); Minoru OWADA, Tokyo (JP); Kazuto SUDA, Tokyo (JP); Weier Wan, Cupertino, CA (US)

(21) Appl. No.: 19/001,603

(22) Filed: Dec. 26, 2024

(51) Int. Cl. H04L 9/32; G06N 3/082; H04L 9/14; H04L 9/40

(52) U.S. Cl. CPC H04L 9/3242; G06N 3/082; H04L 9/14; H04L 63/123

(57) ABSTRACT

An information processing system is provided, wherein a generator-side apparatus generates a first verification value from structure data and weighting factor data of an NN (neural network) and transmits signature data in which the first verification value is encrypted with a private key to a user-side apparatus, and the user-side apparatus generates a second verification value from structure data and weighting factor data of the NN stored therein, decrypts the signature data received from the generator-side apparatus with a public key corresponding to the private key to acquire the first verification value, and determines whether the NN stored therein is falsified or not by comparing the first verification value with the second verification value.

### BACKGROUND

### 1. Technical Field

The present invention relates to an information processing system, a generator-side apparatus, a user-side apparatus, a management method, a verification method, and a computer-readable storage medium.

### 2. Related Art

Patent document 1 describes an apparatus that is aimed to provide technique to improve convenience of users of a learning model of a neural network while suppressing misuse of the learning model.

### PRIOR ART DOCUMENTS

### Patent Document

Patent Document 1: Japanese Patent Application Publication No. 2019-153216

### BRIEF DESCRIPTION OF THE DRAWINGS

FIG. 1 schematically illustrates an example of an information processing system 10.

FIG. 2 schematically illustrates an example of a processing content at the information processing system 10.

FIG. 3 schematically illustrates an example of a processing content at the information processing system 10.

FIG. 4 is an illustration for describing a simplification means 126.

FIG. 5 is an illustration for schematically describing another falsification detection means of a neural network at the information processing system 10.

FIG. 6 is an illustration for schematically describing another falsification detection means of the neural network at the information processing system 10.

FIG. 7 schematically illustrates an example of a functional configuration of a generator-side apparatus 100.

FIG. 8 schematically illustrates an example of a functional configuration of a user-side apparatus 200.

FIG. 9 schematically illustrates an example of a hardware configuration of a computer 1200 that functions as the generator-side apparatus 100 or the user-side apparatus 200.

### DESCRIPTION OF EXEMPLARY EMBODIMENTS

The present invention will be described below through embodiments of the invention, but the following embodiments do not limit the invention according to the claims. In addition, not all of the combinations of features described in the embodiments are essential to the solution of the invention.

In recent years, industrial use of neural networks has increased, and there is an increasing need to prevent theft or misuse of useful neural networks. For example, a means of distinguishing an authentic neural network and an unauthorized neural network by embedding credential in weighting factors or hidden layers of the neural network is can be contemplated. However, there is a problem that, if the credential is embedded in weighting factors or hidden layers in a part of the neural network, falsification in parts in which the credential is not embedded cannot be detected, and even when the credential is matched, it cannot be completely distinguished that it is an unauthorized neural network.

The information processing system 10 according to the present embodiment comprises a function of detecting the falsification and discovering misuses even when weighting factors or hidden layers of a part of the neural network are falsified by a third-party, for example. As one specific example, the information processing system 10 converts data of a file in which a network structure (for example, a layer structure) of the neural network is saved and a file in which weighting factors are saved into a hash value, and generates signature data in which it is encrypt together as a set with a dynamically changing private key. By having the signature data saved, when some of the weighting factors or hidden layers have been falsified, misuse may be able to be appropriately detected since the signature data changes as the hash value is changed.

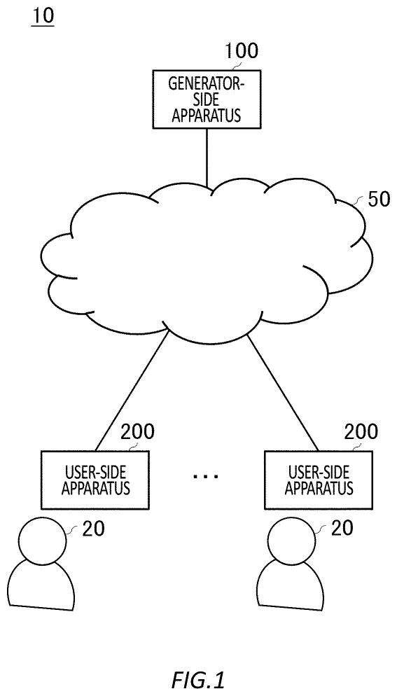

FIG. 1 schematically illustrates an example of an information processing system 10. The information processing system 10 includes a generator-side apparatus 100. The information processing system 10 includes a user-side apparatus 200.

The generator-side apparatus 100 is an apparatus on a generator side of a neural network. The generator-side apparatus 100 may be an apparatus that has been used to generate the neural network. The generator-side apparatus 100 may be an apparatus to manage the neural network generated by the generator. The generator-side apparatus 100 may be a server apparatus, a PC (Personal Computer), as well as a mobile device such as a smartphone and a tablet terminal, and the like.

The user-side apparatus 200 is an apparatus on a user 20 side of the neural network. The user-side apparatus 200 may be an apparatus used by the user 20 who uses the neural network to use the neural network. The user-side apparatus 200 may be a server apparatus, a PC (Personal Computer), as well as a mobile device such as a smartphone and a tablet terminal, and the like.

The generator-side apparatus 100 and the user-side apparatus 200 may communicate with each other via a network 50. The network 50 may include the Internet. The network 50 may include a LAN (Local Area Network). The network 50 may include a mobile communication network. The mobile communication network may conform to any of the LTE (Long Term Evolution) communication system, the 5G (5th Generation) communication system, the 3G (3rd Generation) communication system, and the 6G (6th Generation) communication system and the communication system of the subsequent generation.

The user-side apparatus 200 may acquire the neural network generated by the generator-side apparatus 100 through various methods. The user-side apparatus 200 receives the neural network from the generator-side apparatus 100, for example. The user-side apparatus 200 receives the neural network published on the network 50 by the generator-side apparatus 100, for example. The user-side apparatus 200 receives the neural network generated by the generator-side apparatus 100 from an apparatus other than the generator-side apparatus 100, for example.

There is a possibility that the neural network acquired by the user-side apparatus 200 is falsified after being generated by the generator-side apparatus 100. The information processing system 10 according to the present embodiment has a function that enables determination of whether the neural network is falsified or not.

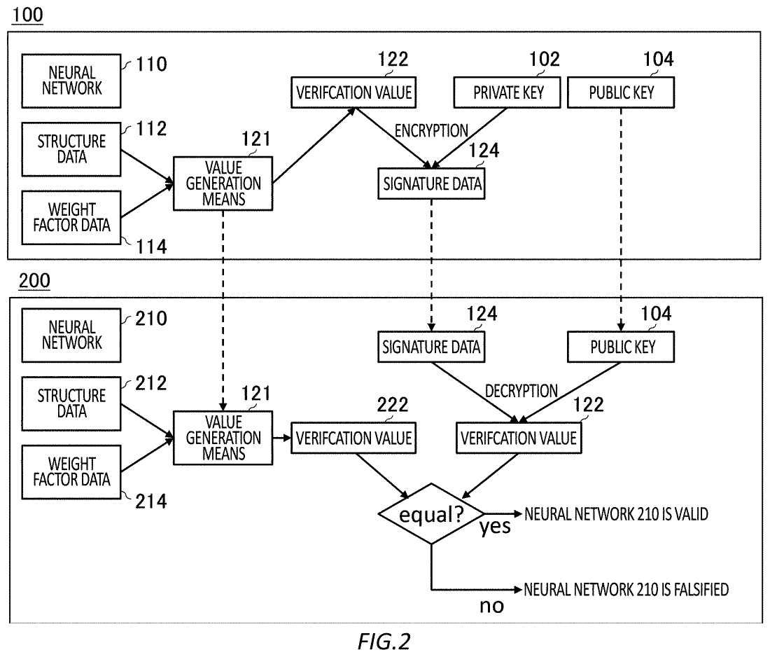

FIG. 2 schematically illustrates an example of a processing content at the information processing system 10. In the example illustrated in FIG. 2, the generator-side apparatus 100 stores a neural network 110, structure data 112 representing a structure of the neural network 110, and weighting factor data 114 including a plurality of weighting factors of the neural network 110.

The structure data 112 may represent a network structure of the neural network 110. For example, the structure data 112 represents a layer structure of a network of the neural network 110. The structure data 112 may represent a structure of an input layer, a hidden layer, and an output layer of the neural network 110.

The weighting factor data 114 includes a plurality of weighting factors of the neural network 110. The weighting factor data 114 includes weighting factors of a plurality of nodes of the neural network 110. The weighting factor data 114 may include a plurality of weighting factor in a matrix form with a plurality of layers of the neural network 110 as the row and the plurality of nodes as the column.

The user-side apparatus 200 stores a neural network 210, structure data 212 representing a structure of the neural network 210, and weighting factor data 214 including a plurality of weighting factors of the neural network 210.

The neural network 210 is the neural network 110 generated by the generator-side apparatus 100 and acquired by the user-side apparatus 200. The neural network 210 may be the same as the neural network 110, or may be a falsified neural network 110. The structure data 212 represents a structure of the neural network 210, similarly to the structure data 112. The weighting factor data 214 includes a plurality of weighting factors, similarly to the weighting factor data 114.

A processing content for determining whether the neural network 210 is falsified or not will be described.

The generator-side apparatus 100 generates a verification value 122 from the structure data 112 and the weighting factor data 114 by using a value generation means 121. The value generation means 121 is a means in which it is ensured that a same value is to be generated from same data, and in which a different value is basically generated from different data. A different value being basically generated from different data may mean that the possibility that a same value is generated from different data is zero. A different value being basically generated from different data may mean that the possibility that a same value is generated from different data is very low.

The value generation means 121 is a hash function, for example. In this case, the verification value 122 is a hash value. The value generation means 121 may be a cryptographic hash function. The value generation means 121 may be SHA-2. For example, the value generation means 121 may be SHA-224, SHA-256, SHA-384, SHA-512, SHA-512/224, SHA-512/256 and the like. The value generation means 121 may be SHA-3. For example, the value generation means 121 may be SHA3-224, SHA3-256, SHA3-384, SHA3-512, SHAKE128, SHAKE256 and the like.

The generator-side apparatus 100 generates signature data 124 in which the verification value 122 is encrypted with a private key 102. The generator-side apparatus 100 may generate a pair of the private key 102 and a public key 104 in advance. The generator-side apparatus 100 may generate the private key 102 and the public key 104 when encrypting the verification value 122. The generator-side apparatus 100 may use an ephemeral key. That is, the private key 102 may be an ephemeral private key, and the public key 104 may be an ephemeral public key.

The generator-side apparatus 100 transmits the generated signature data 124 to the user-side apparatus 200. The generator-side apparatus 100 may transmit the signature data 124 to the user-side apparatus 200 in a manner in which security is secured. For example, the generator-side apparatus 100 transmits the signature data 124 to the user-side apparatus 200 via a secure channel.

The user-side apparatus 200 acquires the public key 104 generated by the generator-side apparatus 100. The user-side apparatus 200 may receive the public key 104 from the generator-side apparatus 100. The user-side apparatus 200 may receive the public key 104 placed on the network 50 by the generator-side apparatus 100.

The user-side apparatus 200 generates a verification value 222 from the structure data 212 and the weighting factor data 214 by using the value generation means 121. The user-side apparatus 200 may receive the value generation means 121 or receive data with which the value generation means 121 can be identified from the generator-side apparatus 100. When receiving the value generation means 121 from the generator-side apparatus 100, the generator-side apparatus 100 may transmit the signature data 124 to the user-side apparatus 200 in a manner in which security is secured, such as by using a secure channel.

The user-side apparatus 200 decrypts the signature data 124 with the public key 104 to acquire the verification value 122. The user-side apparatus 200 compares the verification value 222 with the verification value 122. When the verification value 222 and the verification value 122 are matched, the user-side apparatus 200 may determine that the neural network 210 is valid, that is, that it is not falsified. When the verification value 222 and the verification value 122 are not matched, the user-side apparatus 200 may determine that the user-side apparatus 200 is falsified.

When it is determined that the neural network 210 is falsified, the user-side apparatus 200 may cause the neural network 210 to be unavailable. For example, the user-side apparatus 200 disrupts the neural network 210. For example, the user-side apparatus 200 manages the neural network 210 as an unavailable neural network. For example, the user-side apparatus 200 erases the neural network 210.

Through the processing illustrated in FIG. 2, it can be detected when at least a part of the structure of the neural network is falsified or at least some of the weighting factors of the neural network is falsified.

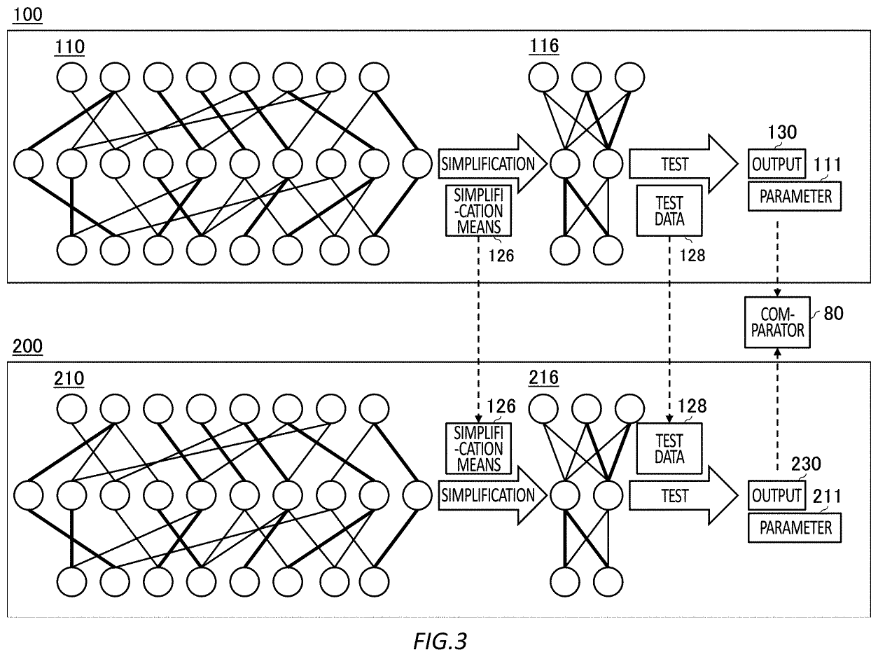

FIG. 3 schematically illustrates an example of a processing content at the information processing system 10. In FIG. 3, a processing content of determining whether the neural network is falsified or not by checking an output by the neural network will be described.

If the neural network is small, it can be determined whether the neural network to be verified is falsified or not by checking a parameter and an output of the original neural network and a parameter and an output of the neural network to be verified. However, if the neural network is large, it is difficult to comprehensively check all parameters of the neural network. Therefore, in the example illustrated in FIG. 3, the information processing system 10 simplifies the neural network. Simplification of the neural network performed by the information processing system 10 may perform coarse-graining of the neural network to renormalize it.

The generator-side apparatus 100 generates a simplified neural network 116 that is by simplifying the neural network 110 by using a pre-registered simplification means 126. The generator-side apparatus 100 inputs test data 128 to the simplified neural network 116 to acquire an output 130 from the simplified neural network 116. The generator-side apparatus 100 may have a plurality of pieces of test data 128 prepared in advance, and may input, to the simplified neural network 116, one piece of test data 128 among a plurality of pieces of test data 128 to acquire one output 130 from the simplified neural network 116. The generator-side apparatus 100 may input more than one of the plurality of pieces of test data 128 to the simplified neural network 116 to acquire a plurality of output 230 from the simplified neural network 116. The generator-side apparatus 100 transmits, to the user-side apparatus 200, the simplification means 126 and the test data 128 used. The generator-side apparatus 100 may transmit, to the user-side apparatus 200, the simplification means 126 and the test data 128 in a manner in which security is secured such as by using a secure channel.

The user-side apparatus 200 generates a simplified neural network 216 by simplifying the neural network 210 by using the simplification means 126 received from the generator-side apparatus 100. The user-side apparatus 200 input the test data 128 received from the generator-side apparatus 100 to the simplified neural network 216 to acquire an output 230 from simplified neural network 216.

The comparison unit 80 then compares the parameter 111 and output 130 of the neural network 110 with the parameter 211 and the output 230 of the neural network 210. The parameter 111 may include a plurality of weighting factors of the neural network 110. The parameter 111 may include a plurality of biases of the neural network 110. The parameter 211 may include a plurality of weighting factors of the neural network 210. The parameter 211 may include a plurality of biases of the neural network 210.

The comparison unit 80 may be included in the generator-side apparatus 100. In this case, the comparison unit 80 receives the parameter 211 and the output 230 from the user-side apparatus 200, and compares the parameter 111 and the output 130 with the parameter 211 and the output 230. The comparison unit 80 may be included in the user-side apparatus 200. In this case, the comparison unit 80 receives the parameter 111 and the output 130 from the generator-side apparatus 100, and compares the parameter 111 and the output 130 with the parameter 211 and the output 230. The comparison unit 80 may be included in an apparatus other than the generator-side apparatus 100 and the user-side apparatus 200. In this case, said apparatus receives the parameter 111 and the output 130 from the generator-side apparatus 100 and receives the parameter 211 and the output 230 from the user-side apparatus 200 and compares them.

The comparison unit 80 may determine that the neural network 210 is falsified when the parameter 111 and the output 130 and the parameter 211 and the output 230 are different. In this manner, it can be determined that there is a possibility of falsification when the neural network 210 is changed from the neural network 110 even a little.

Depending on the neural network 110, update by the user-side may be permitted. For example, depending on the neural network 110, fine tuning by the user-side may be permitted. The parameter 111 changes by the fine tuning of the neural network 110. However, since the fine tuning is aimed at improvement in the performance of the original neural network 110 or at specialization thereof on something, which is based on the neural network 110, the parameter 111 of the neural network 110 will not be greatly changed. On the other hand, falsification of the neural network 110 is aimed at obstructing a function of the neural network 110, or including inappropriate information in the output of the neural network 110, which causes the parameter 111 of the neural network 110 to be greatly changed.

The comparison unit 80 may compare the parameter 111 and the output 130 with the parameter 211 and the output 230 to determine a difference between the parameter 111 and the output 130 and the parameter 211 and the output 230, and determine that it is not falsified when the difference is smaller than a predetermined threshold and determine that it is falsified when the difference is greater than said threshold. Said threshold may be pre-registered. For example, a neural network 210 in which the neural network 110 is subjected to fine tuning and a large amount of neural networks 210 in which the neural network 110 is falsified are prepared, and by determining the difference using the method illustrated in FIG. 3 for both cases, a threshold can be identified with which the difference in the case of fine tuning and the difference in the case of falsification can be distinguished. The comparison unit 80 may use the threshold identified in this manner. In this manner, even when the parameter 211 and the output 230 of the neural network 210 are different from the parameter 111 and the output 130 of the neural network 110, it can be made not to determine that it is falsified in a case where it is due to fine tuning and to determine that it is falsified in a case where it is falsified.

The comparison unit 80 may cause the neural network 210 to be unavailable when it is determined that the neural network 210 is falsified. For example, the comparison unit 80 disrupts the neural network 210. For example, the comparison unit 80 manages the neural network 210 as an unavailable neural network. For example, the comparison unit 80 erases the neural network 210.

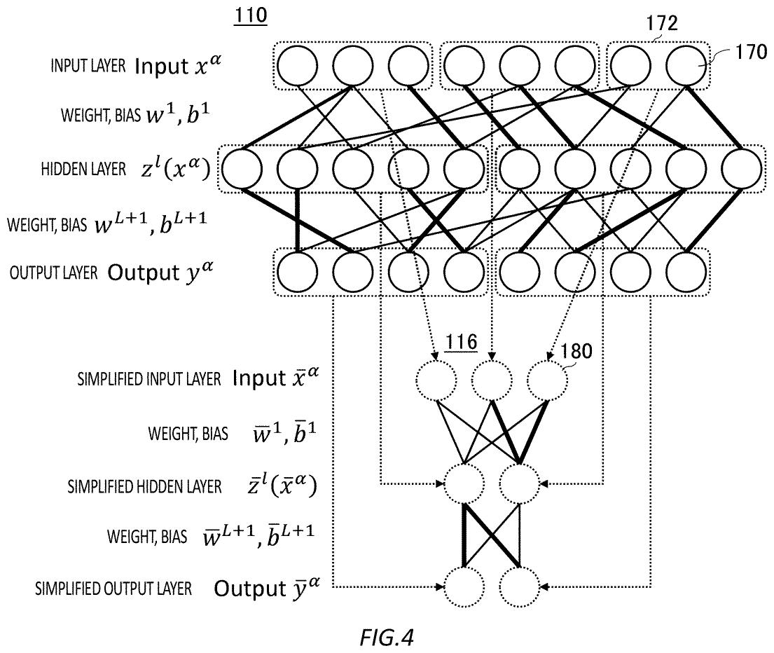

FIG. 4 is an illustration for describing the simplification means 126. The simplification means 126 may be a means to simplify the neural network 110 by performing, for each of a plurality of layers of the neural network 110, grouping of a plurality of nodes 170 included in a layer, and for each group 172, converting a plurality of nodes 170 included in the group 172 into one node 180.

To simplify the description, FIG. 4 illustrates a case in which the neural network 110 comprises an input layer, one hidden layer, and an output layer, the input layer is composed of eight nodes, the hidden layer is composed of ten nodes, and the output layer is composed of eight nodes. The structure of the neural network 110 is not limited thereto, and the number of the hidden layers may be more or less, the number of nodes in each layer may be more or less, and the entire structure may be more complex.

In the example illustrated in FIG. 4, the eight nodes 170 of the input layer are separated into a group 172 of three nodes 170, a group 172 of three nodes 170, and a group 172 of two nodes 170, which are converted into three nodes 180, the ten nodes 170 of the hidden layer are separated into a group 172 of five nodes 170 and a group 172 of five nodes 170, which are converted into two nodes 170, and the eight nodes 170 of the output layer are separated into a group 172 of four nodes 170 and a group 172 of four nodes 170 to be converted into two nodes 180.

The simplification means 126 may be a means to convert, for each group 172, a plurality of nodes 170 included in the group 172 into one node 180 by using an average of the plurality of nodes 170 included in the group 172. The simplification means 126 may use an average of values of the plurality of nodes 170 included in the group 172 as the value of the node 180. The simplification means 126 may use an average of weighting factors of the plurality of nodes 170 included in the group 172 as the weighting factor of the node 180. The simplification means 126 may use an average of biases for the plurality of nodes 170 included in the group 172 as the bias for the node 180.

The simplification means 126 may be a means to convert, for each group 172, a plurality of nodes 170 included in the group 172 into one node 180 by using a maximum value of the plurality of nodes 180 included in the group 172. The simplification means 126 may use a maximum value of values of the plurality of nodes 170 included in the group 172 as the value of the node 180. The simplification means 126 may use a maximum value of weighting factors of the plurality of nodes 170 included in the group 172 as the weighting factor of the node 180. The simplification means 126 may use a maximum value of biases for the plurality of nodes 170 included in the group 172 as the bias for the node 180.

The simplification means 126 may be a means to convert, for each group 172, a plurality of nodes 170 included in the group 172 into one node 180 by performing random sampling from the plurality of nodes 170 included in the group 172. That is, in the simplification means 126, one of the plurality of nodes 170 included in the group 172 may be selected to be the node 180.

When the number of layers in the neural network is large enough, by applying minute perturbation near the input of the neural network, it is theoretically possible to exponentially amplify the influence thereof. It can be assumed that an attacker who is willing to attack the neural network would cause the neural network to not operate normally by using this characteristic and performing falsification by minute perturbation near the input of the neural network such that it will not be discovered. In the simplification means 126, checking may be performed more closely for layers that are closer to the input layer of the neural network. For example, in the simplification means 126, the number of the groups may be increased for the layer, among the plurality of layers of the neural network, that is closer to the input. Conversely, in the simplification means 126, the number of the groups may be reduced for layers that are closer to the output. In this manner, falsification causing the neural network not to operate normally that is performed by applying minute perturbation near the input of the neural network can be efficiently detected.

Hereinbelow, the simplification means 126 will be described with specific examples. Here, description will be made by exemplifying a neural network with L layers, which is represented by the following expression 3, the input to the neural network being represented by the following expression 1 and the output from the neural network being represented by the following expression 2.

$${x}^{α} ∈ {ℝ}^{{N}_{0}} \qquad Expression 1$$

$${y}^{α} ∈ {ℝ}^{{N}_{L + 1}} \qquad Expression 2$$

$${z}_{i}^{1} ( {x}^{α} ) = {\sum }_{j = 1}^{{N}_{0}} {W}_{ij}^{1} {ϕ}^{0} ( {x}_{j}^{α} ) + {b}_{i}^{1} , i = 1 , 2 , … , {N}_{0} \qquad Expression 3$$

$${z}_{i}^{l + 1} ( {x}^{α} ) = {\sum }_{j = 1}^{{N}_{l}} {W}_{ij}^{l + 1} {ϕ}^{l} ( {z}_{j}^{l} ( {x}^{α} ) ) + {b}_{i}^{l} , l = 1 , 2 , … , L - 1 , , i = 1 , 2 , … , {N}_{l + 1}$$

$${y}_{i}^{α} ( {x}^{α} ) = {\sum }_{j = 1}^{{N}_{L + 1}} {W}_{ij}^{L + 1} {ϕ}^{L} ( {z}_{j}^{L} ( {x}^{α} ) ) + {b}_{i}^{L} , i = 1 , 2 , … , {N}_{L + 1} ,$$

In Expression 3, Nₗ represents a width of each layer, φ^{l} represents an activation function of each layer, and the following Expression 4 and Expression 5 represent weighting matrix and biases. It is defined that the parameter θ=(W¹, W², . . . W^{L}, b¹, b², . . . b^{L+1}), and mapping from the input x to the output y(x) is represented in the following expression 6.

$${W}^{l} ∈ {ℝ}^{{N}_{l} \times {N}_{l - 1}} \qquad Expression 4$$

$${W}^{l} ∈ {ℝ}^{{N}_{l} \times {N}_{l - 1}} \qquad Expression 5$$

$$y = f ( x \vert θ ) \qquad Expression 6$$

When the neural network is falsified, the parameters or the activation function will be falsified, for example. If the neural network is small, whether the neural network to be verified is falsified or not can be determined by comparing the output and the parameters of the neural network to be verified for which falsification is verified with the output and the parameters of the original neural network for some inputs x. On the other hand, if the neural network is large, the computation load may become excessive and it may become difficult to realistically perform the verification.

Therefore, the simplification means 126 simplifies the neural network using block pin conversion, for example. For example, in the simplification means 126, as represented in the following expression 7, in order to reduce the resolution Nₗ/kₗ of each of the plurality of layers, for each of the plurality of layers, the degree of freedom k of each group is substituted with its maximum value or average value. Note that, in the simplification means 126, a randomly selected node may be used as a representative for each group. In the simplification means 126, decision may be made through majority vote between positive or negative for each group.

$${\overline{x}}_{I}^{α} = \frac{1}{\sqrt{{k}_{0}}} {\sum }_{i = 1}^{{k}_{0}} \text{?} , \qquad Expression 7$$

$${\overline{W}}_{IJ}^{l} = \frac{1}{\sqrt{{k}_{l} {k}_{l - 1}}} \text{?}$$

$${\overline{b}}_{I}^{l} = \frac{1}{\sqrt{{k}_{l}}} {\sum }_{i = 1}^{{k}_{l}} \text{?} .$$

$$\text{?} \text{indicates text missing or illegible when filed}$$

When the degree of freedom of the hidden layer and the output layer are respectively set as

$$\text{?} ,$$

$$\text{?} \text{indicates text missing or illegible when filed}$$

the simplified neural network is represented by the following expression 8.

$$\text{?} = \text{?} {\overline{W}}_{IJ}^{1} {ϕ}^{0} ( \text{?} ) + {\overline{b}}_{I}^{1} , I = 0 , 1 , … , ⌊ {N}_{0} / {k}_{0} ⌋ \qquad Expression 8$$

$$\text{?} ( {\overline{x}}^{α} ) = \text{?} {\overline{W}}_{IJ}^{l + 1} {ϕ}^{l} ( {\overline{z}}_{j}^{l} ( \text{?} ) ) + \text{?} , l = 1 , 2 , … , L - 1 , , I = 0 , 1 , … , \text{?} ,$$

$$\text{?} = \text{?} {\overline{W}}_{IJ}^{L + 1} {ϕ}^{L} ( {\overline{z}}_{J}^{L} ( {\overline{x}}^{α} ) ) \text{?} , I = 0 , 1 , … , {N}_{L + 1} ,$$

$$\text{?} \text{indicates text missing or illegible when filed}$$

By using 1/instead of 1/k, it can be made possible not to allow non-obvious fluctuation to disappear due to the use of an average or reduction operation.

Instead of using an average in the group, the maximum value or the minimum value in the group may be used. For example, both of the maximum value and the minimum value are identified, and the amplitudes thereof are compared. When the amplitude of the maximum value (or the minimum value) is large, an element of that maximum value (or the minimum value) is used as a simplified element. Instead of using an average in the group, a randomly selected node in the group may be used as a representative. Instead of using an average in the group, decision may be made through majority vote between positive or negative.

Instead of using an average in the group, random sampling from each kₗ₊₁×kₗ in matrix elements W¹, W², . . . W^{L+1} may be performed. In this manner, computation load can be reduced. In this case, the following expression 9 and expression 10 may be used.

$${\overline{W}}_{IJ}^{l} = \sqrt{{k}_{l} {k}_{l - 1} w} \qquad Expression 9$$

$${\overline{b}}_{I}^{l} = \sqrt{{k}_{l}} b \qquad Expression 10$$

w and b may be randomly selected from a set represented by the following expression 11 and expression 12.

$$\{ {W}_{( {Ik}_{l} + i ) ( {JK}_{l - 1} + j )} \text{?} \qquad Expression 11$$

$$\{ \text{?} + i \text{?} \qquad Expression 12$$

$$\text{?} \text{indicates text missing or illegible when filed}$$

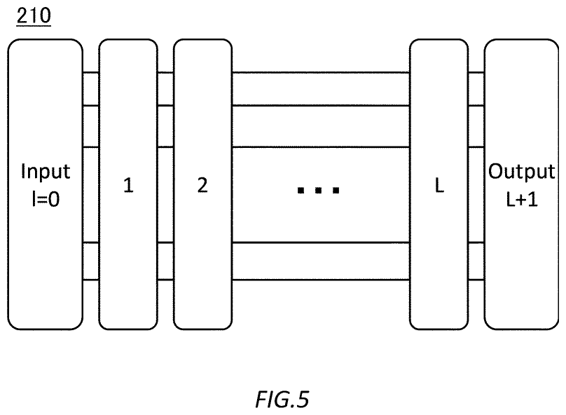

FIG. 5 is an illustration for schematically describing another falsification detection means of a neural network at the information processing system 10. The neural network is generally composed by many layers. Simulation is to be made for how the neural network will be falsified when an attacker who is attempting to attack the neural network attempts to efficiently achieve their purposes.

For example, it can be assumed that the attacker will perform transfer learning on a last layer that is closest to the output of the neural network to train the neural network to provide an inappropriate output. As one specific example, it can be assumed that the attacker will perform transfer learning on the last layer such that an inappropriate character string is always included in the output of the neural network.

For example, the information processing system 10 compares the parameter of the last layer of the neural network 110 with the parameter of the last layer of the neural network 210. The information processing system 10 then determines that the neural network 210 is falsified if there is a different between the parameter of the last layer of the neural network 110 and the parameter of the last layer of the neural network 210, or determines that the neural network 210 is falsified if the difference between the parameter of the last layer of the neural network 110 and the parameter of the last layer of the neural network 210 is greater than a predetermined threshold.

For example, the information processing system 10 inputs test data to the last layer of the neural network 110 to acquire an output, inputs the same test data to the last layer of the neural network 210 to acquire an output, and compares the outputs. The information processing system 10 may then determine that the neural network 210 is falsified if the outputs are different, or may determine that the neural network 210 is falsified if the difference in the outputs is greater than a predetermined threshold. The information processing system 10 may acquire and compare multiple outputs by using different test data.

By doing so, when falsification of performing transfer learning on the last layer of the neural network can be made detectable.

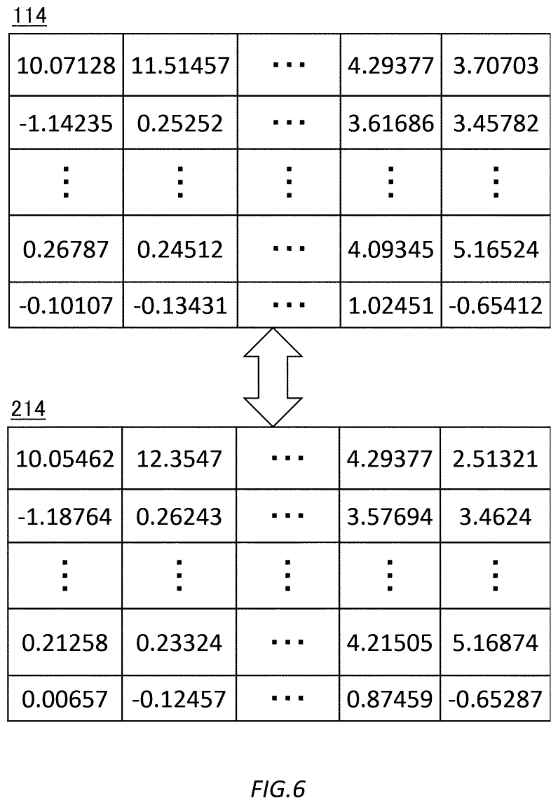

FIG. 6 is an illustration for schematically describing another falsification detection means of the neural network at the information processing system 10. Here, a means for detecting falsification of weighting factors where the weighting factor data 114 and the weighting factor data 214 include a plurality of weighting factors in a matrix form will be described.

For example, the information processing system 10 generates feature information for a particular region in the weighting factor data 114 and the weighting factor data 214, and determines whether the neural network 210 is falsified or not based on a comparison result of the feature information.

The particular region may be one or more rows. The particular region may be one or more columns. The particular region may be one or more rows and one or more columns. The particular region may be a partial matrix range or a plurality of matrix ranges in the entire matrix.

The feature information for the particular region may be a statistic value of a plurality of weighting factors included in the particular region. For example, the feature information for the particular region may be an average value of the plurality of weighting factors included in the particular region. For example, the feature information for the particular region may be a spectrum of a plurality of weighting factors included in the particular region.

The information processing system 10 may determine that the neural network 210 is falsified when the difference between the feature information for the particular region in the weighting factor data 114 and the feature information for the particular region in the weighting factor data 214 is greater than a predetermined threshold. Said threshold may be pre-registered. For example, a neural network 210 in which the neural network 110 is subjected to fine tuning and a large amount of neural networks 210 in which the neural network 110 is falsified are prepared, and by calculating the feature information for the particular region in the weighting factor data 114 and the feature information for the particular region in the weighting factor data 214 for both cases, a threshold can be identified with which the difference in the case of fine tuning and the difference in the case of falsification can be distinguished. The information processing system 10 may have the threshold identified in this manner.

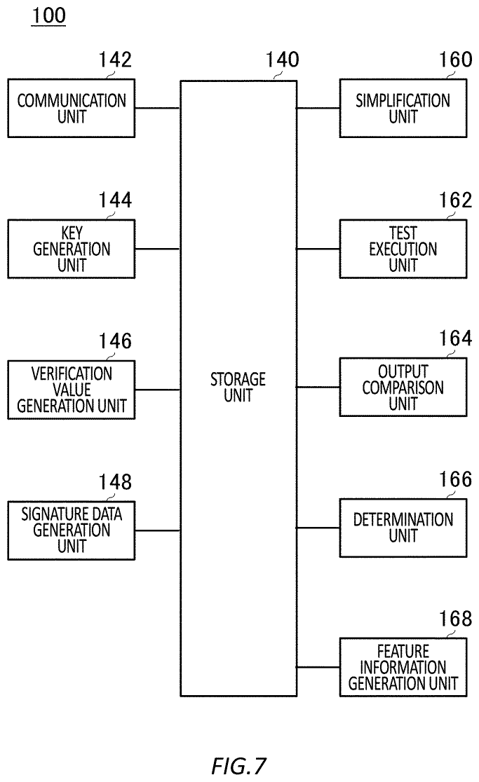

FIG. 7 schematically illustrates an example a functional configuration of the generator-side apparatus 100. The generator-side apparatus 100 comprises a storage unit 140, a communication unit 142, a key generation unit 144 a verification value generation unit 146, a signature data generation unit 148, a simplification unit 160, a test execution unit 162, an output comparison unit 164, a determination unit 166, and a feature information generation unit 168. Note that, the generator-side apparatus 100 does not necessarily comprise all of these.

The storage unit 140 stores various types of data. The storage unit 140 may be an example of the generator-side storage unit. The storage unit 140 may store the neural network 110. The storage unit 140 may store the structure data 112 of the neural network 110. The storage unit 140 may store the parameters 111 of the neural network 110. The storage unit 140 may store the weighting factor data 114 of the neural network 110. The storage unit 140 may store a plurality of neural networks 110. The storage unit 140 may store the structure data 112 of the plurality of neural networks 110. The storage unit 140 may store the parameters 111 of the plurality of neural networks 110. The storage unit 140 may store the weighting factor data 114 of the plurality of neural networks 110. The storage unit 140 may store the value generation means 121. The storage unit 140 may store the simplification means 126. The storage unit 140 may store the test data 128.

The communication unit 142 communicates with another apparatus. The communication unit 142 may be an example of a generator-side communication unit. The communication unit 142 may communicate with the user-side apparatus 200. The communication unit 142 may communicate with an apparatus on the network 50. The communication unit 142 may transmit the neural network 110, the structure data 112, and the weighting factor data 114 stored in the storage unit 140 to the user-side apparatus 200 or to the apparatus on the network 50.

The key generation unit 144 generates the private key 102 and the public key 104. When the private key 102 and the public key 104 are ephemeral keys, the key generation unit 144 may periodically generate the private key 102 and the public key 104, or generate the private key 102 and the public key 104 each time verification of the neural network 210 performed. The key generation unit 144 stores the private key 102 and t public key 104 generated in the storage unit 140. The communication unit 142 transmits the public key 104 to the user-side apparatus 200 or to another apparatus on the network 50.

When performing verification of the neural network 210 corresponding to the neural network 110, the verification value generation unit 146 generates the verification value 122 from the structure data 112 and the weighting factor data 114 by using the value generation means 121. The verification value generation unit 146 may be an example of the generator-side verification value generation unit. The communication unit 142 may notify the user-side apparatus 200 of the value generation means 121 used by the verification value generation unit 146.

The signature data generation unit 148 generates signature data 124 in which the verification value 122 generated by the verification value generation unit 146 is encrypted with the private key 102. The communication unit 142 transmits the signature data 124 generated by the signature data generation unit 148 to the user-side apparatus 200.

The simplification unit 160 generates the simplified neural network 116 in which the neural network 110 stored in the storage unit 140 is simplified by using the pre-registered simplification means 126. The simplification unit 160 may be an example of the generator-side simplification unit.

The test execution unit 162 inputs the test data 128 store in the storage unit 140 to the simplified neural network 116 generated by the simplification unit 160 to acquire the output 130 from the simplified neural network 116. The test execution unit 162 may be an example of the generator-side test execution unit. The communication unit 142 may transmit, to the user-side apparatus 200, the simplification means 126 used by the simplification unit 160 and the test data 128 used by the test execution unit 162.

The output comparison unit 164 may function as the comparison unit 80. The output comparison unit 164 compares the output 130 acquired by the test execution unit 162 and the parameters 111 of the neural network 110 with the output 230 d the parameters 211 acquired from the user-side apparatus 200.

The test execution unit 162 may input the test data 128 to the last layer, among the plurality of layers of the neural network 110 stored in the storage unit 140, that is closest to the output to acquire an output from the last layer. The communication unit 142 may transmit the test data 128 used by the test execution unit 162 to the user-side apparatus 200.

The feature information generation unit 168 generates the feature information for the particular region among the matrix of weighting factors of the neural network 110 stored in the storage unit 140. The feature information generation unit 168 may be an example of the generator-side feature information generation unit.

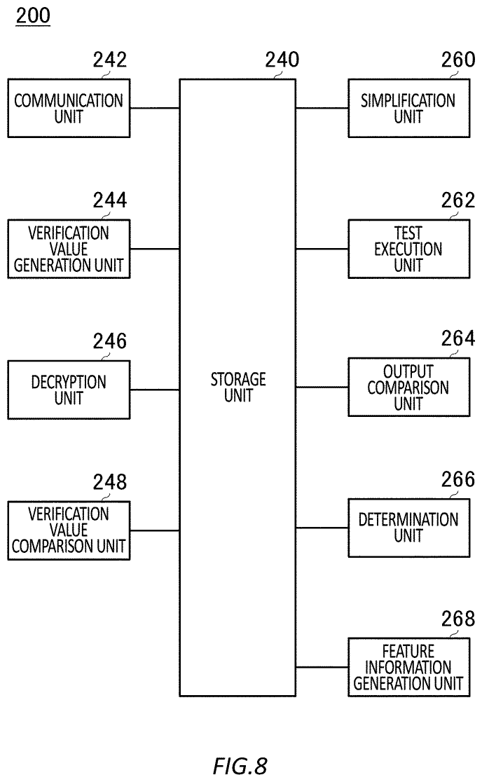

FIG. 8 schematically illustrates an example of a functional configuration of the user-side apparatus 200. The user-side apparatus 200 comprises a storage unit 240, a communication unit 242, a verification value generation unit 244, a decryption unit 246, a verification value comparison unit 248, a simplification unit 260, a test execution unit 262, an output comparison unit 264, a determination unit 266, and a feature information generation unit 268. Note that, the user-side apparatus 200 does not necessarily comprise all of these.

The storage unit 240 stores various types of data. The storage unit 240 may be an example of the user-side storage unit.

The communication unit 242 communicates with another apparatus. The communication unit 242 may be an example of the user-side communication unit. The communication unit 242 stores the data received from another apparatus in the storage unit 240. The communication unit 242 may communicate with the generator-side apparatus 100. The communication unit 242 may communicate with an apparatus on the network 50. The communication unit 242 may receive the neural network 210, the structure data 212, and the weighting factor data 214. The communication unit 242 may receive the value generation means 121 transmitted by the communication unit 142. The communication unit 242 may receive the signature data 124 transmitted by the communication unit 142. The communication unit 242 may receive the public key 104 transmitted by the communication unit 142. The communication unit 242 may receive the public key 104 from an apparatus on the network 50. The communication unit 242 may receive the simplification means 126 transmitted by the communication unit 142. The communication unit 242 may receive the test data 128 transmitted by the communication unit 142. The communication unit 242 may receive the parameters 111 transmitted by the communication unit 142.

When performing verification of the neural network 210, the verification value generation unit 244 generates the verification value 222 from the structure data 212 and the weighting factor data 214 store the storage unit 240 by using the value generation means 121 stored in the storage unit 240. The verification value generation unit 244 may be an example of the user-side verification value generation unit.

The decryption unit 246 decrypts the signature data 124 stored in the storage unit 240 by using the public key 104 stored in the storage unit 240 to acquire the verification value 122.

The verification value comparison unit 248 compares the verification value 122 acquired by the decryption unit 246 with the verification value 222 generated by the verification value generation unit 244. The verification value comparison unit 248 may determine that the neural network 210 is falsified when the verification value 122 and the verification value 222 are different. The verification value comparison unit 248 may cause the neural network 210 to be unavailable when the verification value 122 and the verification value 222 are different.

The simplification unit 260 generates the simplified neural network 216 in which the neural network 210 stored in the storage unit 240 is simplified using the simplification means 126 stored in the storage unit 240. The simplification unit 260 may be an example of the user-side simplification unit.

The test execution unit 262 inputs the test data 128 stored in the storage unit 240 to the simplified neural network 216 generated by the simplification unit 260 to acquire the output 230 from the simplified neural network 216. The test execution unit 262 may be an example of the user-side test execution unit.

The output comparison unit 264 may function as the comparison unit 80. The output comparison unit 264 compares t output 230 acquired by the test execution unit 262 and the parameters 211 of the neural network 210 with the output 130 and the parameters 111 acquired by the generator-side apparatus 100.

The test execution unit 262 may input the test data 128 to the last layer, among the plurality of layers of the neural network 210 stored in the storage unit 240, that is closest to the output to acquire the output from the last layer. The output comparison unit 264 may compare the output acquired by inputting the test data 128 to the last layer of the neural network 210 by the test execution unit 262 with the output acquired by inputting the test data 128 to the last layer of the neural network 110 by the test execution unit 162. Said comparison may be performed by the output comparison unit 164. That is, the output comparison unit 164 may compare the output acquired by inputting the test data 128 to the last layer of the neural network 110 the test execution unit 162 with the output acquired by inputting the test data 128 to the last layer of the neural network 210 by the test execution unit 262.

The determination unit 266 may determine that the neural network 210 is falsified when pre-registered falsification determination data is included in the output acquired by the test execution unit 262. The falsification determination data may be data which is inappropriate to be included in the output of the neural network 210. For example, when the output of the neural network 210 is in a text form, the falsification determination data may be an inappropriate word or an inappropriate sentence. For example, when the output of the neural network 210 is an image, the falsification determination data may be an inappropriate image. The determination unit 266 may cause the neural network 210 to be unavailable when the neural network 210 is determined to be falsified. For example, the determination unit 266 disrupts the neural network 210. For example, e determination unit 266 manages the neural network 210 as an unavailable neural network. For example, the determination unit 266 erases the neural network 210. In this manner, when the neural network 110 is falsified to output inappropriate data through transfer learning, it can be efficiently detected.

The feature information generation unit 268 generates the feature information for the particular region among the matrix of weighting factors of the neural network 210 stored in the storage unit 240. The feature information generation unit 268 may be an example of the user-side feature information generation unit. The determination unit 266 determines whether the neural network 210 is falsified or not based on the comparison result between the feature information generated by the feature information generation unit 168 and the feature information generated by the feature information generation unit 268. The determination unit 266 may determine that the neural network 210 is falsified when the difference between the feature information generated by the feature information generation unit 168 and the feature information generated by the feature information generation unit 268 is greater than a predetermined threshold. The determination unit 266 may cause the neural network 210 to be unavailable when the neural network 210 is determined to be falsified. Said determination may be made by the determination unit 166. That is, the determination unit 166 determines whether the neural network 210 is falsified or not based on the comparison result between the feature information generated by the feature information generation unit 168 and the feature information generated by the feature information generation unit 268. The determination unit 166 may determine that the neural network 210 is falsified when the difference between the feature information generated by the feature information generation unit 168 and the feature information generated by the feature information generation unit 268 is greater than the predetermined threshold. The determination unit 166 may cause the neural network 210 to be unavailable when the neural network 210 is determined to be falsified.

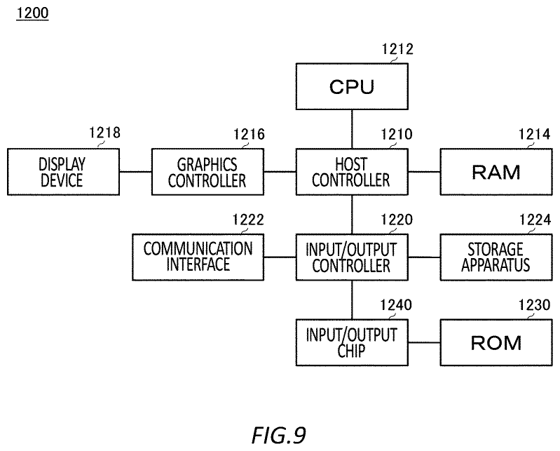

FIG. 9 schematically illustrates an example of a hardware configuration of a computer 1200 that functions as the generator-side apparatus 100 or the user-side apparatus 200. A program installed in the computer 1200 can cause the computer 1200 to function as one or more “units” of an apparatus according to the present embodiment, or cause the computer 1200 to perform operations associated with the apparatus or perform one or more “units” thereof according to the present embodiment, and/or cause the computer 1200 to perform the process according to the present embodiment or perform the steps of the process. Such a program may be executed by a CPU 1212 to cause the computer 1200 to execute specific operations associated with some or all of the blocks in the flowcharts and block diagrams described in the present specification.

The computer 1200 according to the present embodiment includes the CPU 1212, a RAM 1214, and a graphics controller 1216, which are connected to each other via a host controller 1210. The computer 1200 also includes input/output units such as a communication interface 1222, a storage apparatus 1224, a DVD drive and an IC card drive, which are connected to the host controller 1210 via an input/output controller 1220. The DVD drive may be a DVD-ROM drive, a DVD-RAM drive, etc. The storage apparatus 1224 may be a hard disk drive, a solid-state drive, and the like. The computer 1200 also includes a ROM 1230 and a legacy input/output unit such as a keyboard, which are connected to the input/output controller 1220 through an input/output chip 1240.

The CPU 1212 operates in accordance with the programs stored in the ROM 1230 and the RAM 1214, thereby controlling each unit. The graphics controller 1216 obtains image data which is generated by the CPU 1212 in a frame buffer or the like provided in the RAM 1214 or in itself so as to cause the image data to be displayed on a display device 1218.

The communication interface 1222 communicates with other electronic devices via a network. The storage apparatus 1224 stores a program and data used by the CPU 1212 in the computer 1200. The DVD drive reads the programs or the data from the DVD-ROM or the like, and provides the storage apparatus 1224 with the programs or the data. The IC card drive reads programs and data from an IC card and/or writes programs and data into the IC card.

The ROM 1230 stores therein a boot program or the like executed by the computer 1200 at the time of activation, and/or a program depending on the hardware of the computer 1200. The input/output chip 1240 may also connect various input/output units via a USB port, a parallel port, a serial port, a keyboard port, a mouse port, or the like to the input/output controller 1220.

A program is provided by a computer-readable storage medium such as the DVD-ROM or the IC card. The program is read from the computer-readable storage medium, installed into the storage apparatus 1224, RAM 1214, or ROM 1230, which are also examples of a computer-readable storage medium, and executed by the CPU 1212. Information processing written in these programs is read by the computer 1200, and provides cooperation between the programs and the various types of hardware resources described above. An apparatus or method may be configured by achieving the operation or processing of information in accordance with the usage of the computer 1200.

For example, when a communication is performed between the computer 1200 and an external device, the CPU 1212 may execute a communication program loaded in the RAM 1214 and instruct the communication interface 1222 to perform communication processing based on a process written in the communication program. The communication interface 1222, under control of the CPU 1212, reads transmission data stored on a transmission buffer region provided in a recording medium such as the RAM 1214, the storage apparatus 1224, the DVD-ROM, or the IC card, and transmits the read transmission data to a network or writes reception data received from a network to a reception buffer region or the like provided on the recording medium.

In addition, the CPU 1212 may cause all or a necessary portion of a file or a database to be read into the RAM 1214, the file or the database having been stored in an external recording medium such as the storage apparatus 1224, the DVD drive (DVD-ROM), the IC card, etc., and perform various types of processing on the data on the RAM 1214. Next, the CPU 1212 may write the processed data back into the external recording medium.

Various types of information, such as various types of programs, data, tables, and databases, may be stored in the recording medium to undergo information processing. The CPU 1212 may execute, on the data read from the RAM 1214, various types of processing including various types of operations, information processing, conditional judgement, conditional branching, unconditional branching, information search/replacement, or the like described throughout the present disclosure and designated by instruction sequences of the programs, to write the results back to the RAM 1214. In addition, the CPU 1212 may search for information in a file, a database, or the like in the recording medium. For example, when a plurality of entries, each having an attribute value of a first attribute associated with an attribute value of a second attribute, are stored in the recording medium, the CPU 1212 may search for an entry whose attribute value of the first attribute matches a designated condition, from among the plurality of entries, and read the attribute value of the second attribute stored in the entry, thereby obtaining the attribute value of the second attribute associated with the first attribute that satisfies a predetermined condition.

The above described program or software modules may be stored in the computer-readable storage medium on or near the computer 1200. In addition, a recording medium such as a hard disk or a RAM provided in a server system connected to a dedicated communication network or the Internet can be used as the computer-readable storage medium, thereby providing the program to the computer 1200 via the network.

Blocks in flowcharts and block diagrams in the present embodiments may represent stages of processes in which operations are executed or “units” of apparatuses responsible for executing operations. A specific stage and “unit” may be implemented by dedicated circuit, programmable circuit supplied along with a computer-readable instruction stored on a computer-readable storage medium, and/or a processor supplied along with the computer-readable instruction stored on the computer-readable storage medium. The dedicated circuit may include a digital and/or analog hardware circuit, or may include an integrated circuit (IC) and/or a discrete circuit. The programmable circuit may include, for example, a reconfigurable hardware circuit including logical AND, logical OR, logical XOR, logical NAND, logical NOR, and another logical operation, and a flip-flop, a register, and a memory element, such as a field programmable gate array (FPGA), a programmable logic array (PLA), or the like.

The computer-readable storage medium may include any tangible device capable of storing an instruction executed by an appropriate device, so that the computer-readable storage medium having the instruction stored thereon constitutes a product including an instruction that may be executed in order to provide means for executing an operation designated by a flowchart or a block diagram. Examples of the computer-readable storage medium may include an electronic storage medium, a magnetic storage medium, an optical storage medium, an electromagnetic storage medium, a semiconductor storage medium, and the like. More specific examples of the computer-readable storage medium may include a floppy (registered trademark) disk, a diskette, a hard disk, a random access memory (RAM), a read only memory (ROM), an erasable programmable read only memory (EPROM or flash memory), an electrically erasable programmable read only memory (EEPROM), a static random access memory (SRAM), a compact disk read only memory (CD-ROM), a digital versatile disk (DVD), a Blu-ray (registered trademark) disk, a memory stick, an integrated circuit card, or the like.

The computer-readable instructions may include an assembler instruction, an instruction-set-architecture (ISA) instruction, a machine instruction, a machine dependent instruction, a microcode, a firmware instruction, state-setting data, or either of source code or object code written in any combination of one or more programming languages including an object oriented programming language such as Smalltalk (registered trademark), JAVA (registered trademark), and C++, or the like, and a conventional procedural programming language such as a “C” programming language or a similar programming language.

The computer-readable instruction may be provided to a processor or a programmable circuit of a general purpose computer, a special purpose computer, or another programmable data processing apparatus locally or via local area network (LAN), or wide area network (WAN) such as the Internet in order to execute said computer-readable instruction to generate means to perform operations designated in the flowchart or the block diagram by the processor or programmable circuit of the programmable data processing apparatus as the computer. Here, the computer may be a personal computer (PC), a tablet computer, a smartphone, a workstation, a server computer, or a computer such as a general purpose computer or a special purpose computer, or may be a computer system to which a plurality of computers are connected. Such computer system to which the plurality of computers are connected is also referred to as a distributed computing system, and is a computer in a broad sense. In a distributed computing system, a plurality of computers collectively execute a program by each of the plurality of computers executing a portion of the program, and passing data during the execution of the program among the computers as needed.

Examples of the processor include a computer processor, a central processing unit, a processing unit, a microprocessor, a digital signal processor, a controller, a microcontroller or the like. The computer may include one processor or a plurality of processors. In a multi-processor system including a plurality of processors, the plurality of processors collectively execute a program by each of the processors executing a portion of the program, and passing data during the execution of the program among the processors as needed. For example, in execution of multiple tasks, each of the plurality of processors may execute a portion of each task pieces by pieces by performing task-switching for each time slice. In this case, which portion of one program each processor is responsible for executing dynamically changes. Moreover, which portion of the program each of the plurality of processors is responsible for executing may be determined statically by multiprocessor-aware programming.

While the present invention has been described by way of the embodiments, the technical scope of the present invention is not limited to the scope described in the above-described embodiments. It is apparent to persons skilled in the art that various alterations or improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

10: information processing system, 20: user, 50: network, 100: generator-side apparatus, 102: private key, 104: public key, 110: neural network, 111: parameter, 112: structure data, 114: weighting factor data, 121: value generation means, 122: verification value, 124: signature data, 126: simplification means, 128: test data, 130: output, 140: storage unit, 142: communication unit, 144: key generation unit, 146: verification value generation unit, 148: signature data generation unit, 160: simplification unit, 162: test execution unit, 164: output comparison unit, 166: determination unit, 168: feature information generation unit, 170: node, 172: group, 200: user-side apparatus, 210: neural network, 211: parameter, 212: structure data, 214: weighting factor data, 222: verification value, 230: output, 240: storage unit, 242: communication unit, 244: verification value generation unit, 246: decryption unit, 248: comparison unit, 260: simplification unit, 262: test execution unit, 264: output comparison unit, 266: determination unit, 268: feature information generation unit, 1200: computer, 1210: host controller, 1212: CPU, 1214: RAM, 1216: graphics controller, 1218: display device, 1220: input/output controller, 1222: communication interface, 1224: storage apparatus, 1230: ROM, 1240: input/output chip.

What is claimed is:

1. An information processing system comprising a generator-side apparatus and a user-side apparatus of a neural network, wherein
the generator-side apparatus includes:
a generator-side storage unit that stores the neural network, structure data representing a structure of the neural network, weighting factor data including a plurality of weighting factors of the neural network, and a pair of a private key and a public key;
a generator-side verification value generation unit that generates a first verification value from the structure data and the weighting factor data by using a value generation means in which it is ensured that a same value is to be generated from same data, and in which a different value is basically generated from different data;
a signature data generation unit that generates signature data in which the first verification value is encrypted with the private key; and
a generator-side communication unit that transmits the signature data to the user-side apparatus, and
the user-side apparatus includes:
a user-side storage unit that stores a neural network, structure data representing a structure of the neural network, weighting factor data including a plurality of weighting factors of the neural network, and the public key;
a user-side verification value generation unit that generates a second verification value from the structure data and the weighting factor data stored in the user-side storage unit by using the value generation means;
a decryption unit that decrypts the signature data received from the generator-side apparatus with the public key to acquire the first verification value; and
a verification value comparison unit that compares the first verification value with the second verification value.

2. The information processing system according to claim 1, wherein
the value generation means is a hash function, and
the verification value is a hash value.

3. The information processing system according to claim 1, wherein the verification value comparison unit causes the neural network stored in the user-side storage unit to be unavailable when the first verification value and the second verification value are different.

4. The information processing system according to claim 1, wherein
the generator-side apparatus includes:
a generator-side simplification unit that generates a simplified neural network by simplifying the neural network stored in the generator-side storage unit by using a pre-registered simplification means; and
a generator-side test execution unit that inputs test data to the simplified neural network generated by the generator-side simplification unit to acquire an output from the simplified neural network,
wherein the user-side communication unit transmits the simplification means and the test data to the user-side apparatus,
the user-side apparatus includes:
a user-side simplification unit that generates a simplified neural network by simplifying the neural network stored in the user-side storage unit by using the simplification means; and
a user-side test execution unit that inputs the test data to the simplified neural network generated by the user-side simplification unit to acquire an output from the simplified neural network,
the information processing system comprising:
an output comparison unit that compares the output acquired by the generator-side test execution unit and the output acquired by the user-side test execution unit.

5. The information processing system according to claim 4, wherein the simplification means is a means to simplify the neural network by performing, for each of a plurality of layers of a neural network, grouping of a plurality of nodes included in a layer, and for each group, converting a plurality of nodes included in the group into one node.

6. The information processing system according to claim 5, wherein the simplification means is a means to convert the plurality of nodes included in the group into one node by, for each group, any of random sampling from the plurality of nodes included in the group, use of an average value of the plurality of nodes included in the group, or use of a maximum value among the plurality of nodes included in the group.

7. The information processing system according to claim 5, wherein in the simplification means, a number of the group is increased for a layer, among the plurality of layers of the neural network, that is closer to an input.

8. The information processing system according to claim 1, wherein
the generator-side apparatus includes a generator-side test execution unit that inputs test data to a last layer, among a plurality of layers of the neural network stored in the generator-side storage unit, that is closest to an output to acquire an output of the last layer,
the user-side communication unit transmits the test data to the user-side apparatus, and
the user-side apparatus includes a user-side test execution unit that inputs the test data to a last layer, among a plurality of layers of the neural network stored in the user-side storage unit, that is closest to an output, to acquire an output from the last layer,
the information processing system comprising:
an output comparison unit that compares the output acquired by the generator-side test execution unit with the output acquired by the user-side test execution unit.

9. The information processing system according to claim 1, wherein
the user-side apparatus includes a user-side test execution unit that inputs test data to a last layer, among a plurality of layers of the neural network stored in the user-side storage unit, that is closest to an output, to acquire an output from the last layer,
the information processing system comprising:
a determination unit that determines that the neural network stored in the user-side storage unit is falsified when the output acquired by the user-side test execution unit includes pre-registered falsification determination data.

10. The information processing system according to claim 1, wherein
the generator-side apparatus includes a generator-side feature information generation unit that generates feature information for a particular region among a matrix of the plurality of weighting factors of the neural network stored in the generator-side storage unit, and
the user-side apparatus includes a user-side feature information generation unit that generates feature information for a particular region among a matrix of the plurality of weighting factors of the neural network stored in the user-side storage unit,
the information processing system comprising:
a determination unit that determines whether the neural network stored in the user-side storage unit is falsified or not based on a comparison result between the feature information generated by the generator-side feature information generation unit and the feature information generated by the user-side feature information generation unit.

11. The information processing system according to claim 10, wherein the determination unit determines that the neural network is falsified when a difference between the feature information generated by the generator-side feature information generation unit and the feature information generated by the user-side feature information generation unit is greater than a predetermined threshold.

12. A generator-side apparatus of a neural network, comprising:
a generator-side storage unit that stores the neural network, structure data representing a structure of the neural network, weighting factor data including a plurality of weighting factors of the neural network, and a pair of a private key and a public key;
a generator-side verification value generation unit that generates a first verification value from the structure data and the weighting factor data by using a value generation means in which it is ensured that a same value is to be generated from same data, and in which a different value is basically generated from different data;
a signature data generation unit that generates signature data in which the first verification value is encrypted with the private key; and
a generator-side communication unit that transmits the signature data to the user-side apparatus that uses the neural network.

13. A user-side apparatus of a neural network, comprising:
a user-side storage unit that stores the neural network, structure data representing a structure of the neural network, and weighting factor data including a plurality of weighting factors of the neural network;
a user-side verification value generation unit that generates a verification value from the structure data and the weighting factor data stored in the user-side storage unit by using a value generation means in which it is ensured that a same value is to be generated from same data, and in which a different value is basically generated from different data;
a decryption unit that decrypts, with a public key corresponding to a private key, signature data, which is received from a generator-side apparatus of the neural network and in which a verification value generated by the generator-side apparatus from structure data and weighting factor data of a neural network stored in a generator-side storage unit of the generator-side apparatus by using the value generation means is encrypted with the private key, to acquire the verification value; and
a verification value comparison unit that compares the verification value acquired by the decryption unit with the verification value generated by the user-side verification value generation unit.

14. A non-transitory computer-readable storage medium having stored thereon a program that causes a generator-side apparatus of a neural network to perform steps of:
storing, in a generator-side storage unit, the neural network, structure data representing a structure of the neural network, weighting factor data including a plurality of weighting factors of the neural network, and a pair of a private key and a public key;
generating a generator-side verification value by generating a first verification value from the structure data and the weighting factor data by using a value generation means in which it is ensured that a same value is to be generated from same data, and in which a different value is basically generated from different data;
generating signature data in which the first verification value is encrypted with the private key; and
transmitting the signature data to a user-side apparatus that uses the neural network.

15. A management method performed by a generator-side apparatus of a neural network, the method comprising:
storing, in a generator-side storage unit, the neural network, structure data representing a structure of the neural network, weighting factor data including a plurality of weighting factors of the neural network, and a pair of a private key and a public key;
generating a generator-side verification value by generating a first verification value from the structure data and the weighting factor data by using a value generation means in which it is ensured that a same value is to be generated from same data, and in which a different value is basically generated from different data;
generating signature data in which the first verification value is encrypted with the private key; and
transmitting the signature data to a user-side apparatus that uses the neural network.

16. A non-transitory computer-readable storage medium having stored thereon a program that causes a user-side apparatus of a neural network to perform steps of:
storing, in a user-side storage unit, the neural network, structure data representing a structure of the neural network, and weighting factor data including a plurality of weighting factors of the neural network;
generating a user-side verification value by generating a verification value from the structure data and the weighting factor data stored in the user-side storage unit by using a value generation means in which it is ensured that a same value is to be generated from same data, and in which a different value is basically generated from different data;
decrypting, with a public key corresponding to a private key signature data, which is received from a generator-side apparatus of the neural network and in which a verification value generated by the generator-side apparatus from structure data and weighting factor data of a neural network stored in a generator-side storage unit of the generator-side apparatus by using the value generation means is encrypted with the private key, to acquire the verification value; and
comparing the verification value acquired in the decrypting with the verification value generated in the generating the user-side verification value.

17. A verification method performed by a user-side apparatus of a neural network, the method comprising:
storing, in a user-side storage unit, the neural network, structure data representing a structure of the neural network, weighting factor data including a plurality of weighting factors of the neural network;
generating a user-side verification value by generating a verification value from the structure data and the weighting factor data stored in the user-side storage unit by using a value generation means in which it is ensured that a same value is to be generated from same data, and in which a different value is basically generated from different data;
decrypting signature data, which is received from a generator-side apparatus of the neural network, in which a verification value generated by the generator-side apparatus from structure data and weighting factor data of a neural network stored in a generator-side storage unit of the generator-side apparatus by using the value generation means is encrypted with a private key, with a public key corresponding to the private key, to acquire the verification value; and
comparing the verification value acquired in the decrypting with the verification value generated in the generating the user-side verification value.
